(19) United States
(12) Patent Application Publication
(10) Pub. No.: US 2009/0123151 A1
(43) Pub. Date: May 14, 2009

(54) Adaptive ONT for a PON Network

(76) Inventors: Thomas Nagel, Boca Raton, FL (US); Schah Walli Ali, Boca Raton, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/886,760

(22) PCT Filed: Mar. 17, 2006
(86) PCT No.: PCT/EP2006/060832

§ 371 Date: Sep. 20, 2007

Related U.S. Application Data
(60) Provisional application No. 60/667,365, filed on Mar. 31, 2005.

(51) Int. Cl. H04J 14/00

(52) U.S. Cl. 398/45

(57) ABSTRACT

A method for recognizing and adapting to a change in a passive optical network (PON) format by an optical network terminal (ONT) in communication with an optical line terminal (OLT) over the PON includes pre-loading a plurality of transmission formats and content formats into an individual ONT. The method also includes automatically identifying at the ONT a transmission format of a downstream signal transmitted over a PON from an OLT to the ONT corresponding to at least one of the preloaded transmission formats. The method further includes automatically identifying at the ONT a content format of the downstream signal corresponding to at least one of the preloaded content formats and automatically adapting the ONT to recover information from the downstream signal according to the identified transmission format and the identified content format.

### CROSS-REFERENCE TO RELATED APPLICATIONS

The present application claims the benefit of the provisional patent application filed on Mar. 31, 2005, and assigned application No. 60/667,365.

### FIELD OF THE INVENTION

The present invention relates generally to passive optical networks, and more particularly to an adaptive optical network terminal (ONT) for automatically accommodating different types of passive optical networks (PON's).

### BACKGROUND OF THE INVENTION

The use of fiber optic-based networks to carry information signals continues to grow in popularity worldwide. Such networks employ optical data transmitters at a source node for converting electrical signals to optical signals for transmission over the network. At a destination node the optical signals are converted back to electrical form for processing and extracting the information signal.

Optical networks are classified as active or passive. An active optical network comprises intermediate nodes (disposed between the source and destination nodes) for regenerating the optical signal using a receiver/transmitter (i.e., transceiver) that provides optical-to-electrical-to-optical conversion and amplification of the signal in electrical form. A passive optical network (PON) architecture does not employ intermediate nodes, but instead comprises beam splitters and filters to direct the optical signal to its intended destination node.

A PON typically provides multiple data transmission paths, each capable of delivering high-bandwidth data services to multiple users. A PON may be operated according under a variety of different transmission standards, such as a B-PON (broadband passive optical network) or a G-PON (gigabit passive optical network), Each standard may have respective different transmission bandwidths and, transmission speeds and may include respective different media access control (MAC) information and operation, administration and management (OAM) information encoding schemes.

A PON network typically includes an optical line terminal (OLT) at a network head end and a plurality of optical network terminals (ONT's) located at or proximate a subscriber's site. Each ONT may connect to several subscribers, permitting each subscriber to access the passive optical network and connect to other networks through the PON. The conventional PON topology comprises a shared upstream signal path and a broadcast downstream path. Downstream data includes an address header and may be encoded with MAC and/or OEM information. The downstream data is broadcast from the OLT to downstream ONT's. All ONT's receive the broadcasted data and each employs an address matching process to identify data intended for it.

### BRIEF DESCRIPTION OF THE DRAWINGS

The invention is explained in following description in view of the drawings that show:

FIG. 1 is an example embodiment of an adaptive ONT.

FIG. 2 is example flow chart for a method for recognizing and adapting to a change in PON format at an ONT.

FIG. 3 is an example flow chart for a PON format discovery process.

### DETAILED DESCRIPTION OF THE INVENTION

Typically, PON ONT's are designed to support specific PON standards that are determined by PON information encoding schemes, such as PON MAC functionality and bandwidth, in an upstream and downstream direction. Accordingly, when upgrading or changing a network standard of a PON network, such as changing a MAC functionality characteristic and/or bandwidth of the PON network, existing ONT's must be replaced with ONT's compatible with the new network standard. The inventors of the present invention have innovatively developed a ONT that automatically recognizes and adapts to a change in a network standard of the PON network to which it is connected, such as when the PON network is upgraded.

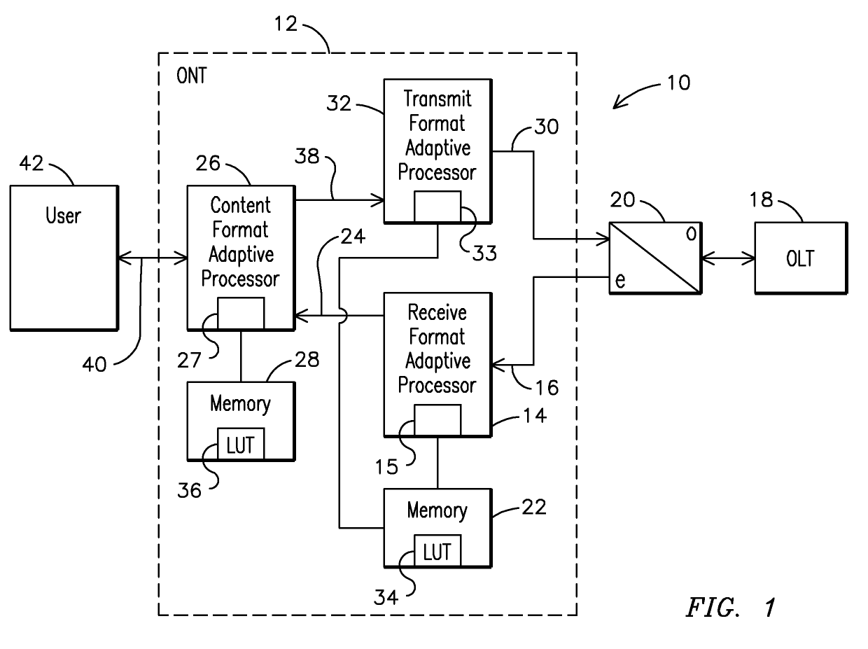

FIG. 1 shows an example embodiment of an adaptive ONT 12 of a PON 10 that automatically recognizes and adapts to a variety of PON formats, including PON transmission formats, such as bandwidth of a downstream signal 16, and PON content formats, such as MAC functionality. In an embodiment, the ONT 12 includes a receive adaptive processor 14 receiving a downstream signal 16 from an OLT 18 via an optical signal to electrical signal converter 20. The receive adaptive processor 14 is configured for automatically identifying a transmission format of the downstream signal 16 and for automatically adapting itself to recover data from the signal 16 according to the identified transmission format. The receive adaptive processor 14 may be in communication with a receive format memory 22 that may be used for storing different receive formats, such as different clock ranges and/or data ranges, that the ONT 12 may be expected to receive. In an aspect of the invention, the receive format memory 22 may be preloaded with different receive formats, such as prior to installation in a PON 10. In another aspect, the receive format memory 22 may be updated or loaded remotely, for example, when already connected to a PON 10.

The receive adaptive processor 14 may include logic 15 executable by the processor 14 for sequentially comparing ones of the different content receive formats stored in the receive format memory 22 to a receive format of the downstream signal 16, such as a data or clock format of the downstream signal 16. The logic 15 may by configured for identifying a receive format match between at least one of the different receive formats and the receive format of the downstream signal 16. When a match is found, the logic 15 may be further configured for recovering data from the downstream signal 16 according to the receive format match and then providing the recovered data 24 to a downstream content adaptive processor 26.

The content adaptive processor 26 may be configured for automatically identifying a content format of the recovered data 24 and for automatically adapting itself to interpret the recovered data 24 according to the identified content format. For example the content adaptive processor 26 may be configured for identifying content format such as a MAC code of the downstream signal 16. The MAC code may include an OEM code and/or a signal synchronization that is recognizable by the content adaptive processor 26 to allow the processor 26 to determine a content format of the downstream signal 16 and then configure itself appropriately. The content adaptive processor 26 may be in communication with a content format memory 28 storing different content formats, such as different MAC codes that may be preloaded and/or updated or loaded remotely.

The content adaptive processor 26 may include logic 27 executable by the processor 26 for sequentially comparing ones of the different content formats stored in the content format memory 28 to a content format of the recovered data 24. The logic 27 may also be configured for identifying a content format match between one of the different content formats stored in content format memory 28 and the content format of the recovered data 24. When a match is found, the logic 27 may be further configured for providing content interpreted data 40 to a downstream data user 42, such as a cable modem subscriber, according to the content format match.

The content adaptive processor 26 may be further configured to adapt itself to a format a content of an upstream signal 30 responsive to the identified content format of the downstream signal 16. For example, the logic 27 executable by the processor 26 may be further configured for formatting a content of the upstream signal 30 responsive to the content format match. The logic 27 may be configured for accessing a look up table 36 in memory 28 storing a plurality of content formats corresponding to respective receive content formats to determine an appropriate upstream content format to be used.

A transmit format adaptive processor 32 may be provided for receiving a content formatted upstream signal 38 from the content format adaptive processor 26 and transmitting the upstream signal according to an upstream signal transmit property of the PON 10. For example, the transmit format adaptive processor 32 may include logic 33 executable by the processor 32 for configuring a transmit format of the content formatted upstream signal 38 responsive to the receive format match. In an embodiment, the processor 26 may configure the upstream transmit format according to format information provided in the downstream signal 16. In another embodiment, the processor 32 may configure the upstream transmit format by accessing a look up table 34 in memory 22 storing a plurality of transmit formats corresponding to respective receive formats to determine the appropriate upstream transmission format to be used.

FIG. 2 illustrates an example process of PON format identification and adaptation that may be employed by the OLT of FIG. 1. The process may begin for example, when a loss of optical signal is caused by an exchange of a first PON OLT with a second PON OLT that may have different PON link properties, such as receive format and/or content format properties 44. After exchange and reestablishment of a downstream signal 16 received by the OLT for the second OLT, the ONT begins a PON format discovery phase to determine upstream and downstream link properties associated with the second OLN 46. After the OLT identifies upstream and downstream properties of the new PON link, the OLT automatically configures itself according to the identified link properties and may then conduct conventional frequency ranging activities 48 and resume communications according to the new properties 50.

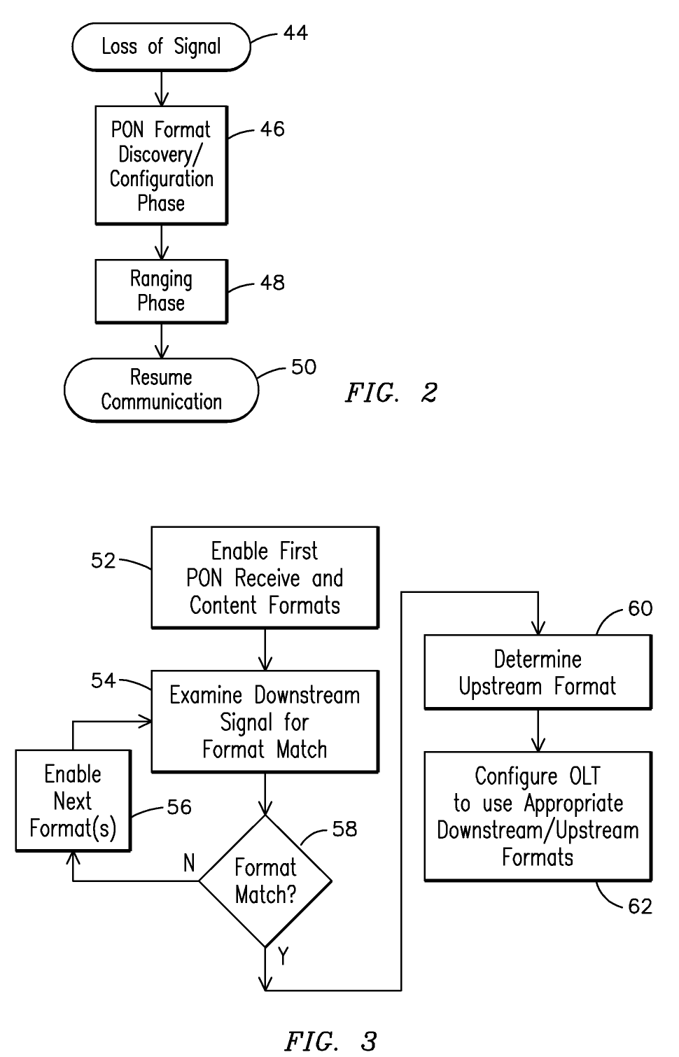

FIG. 3 illustrates in greater detail the discovery process of FIG. 2. The discovery phase may begin with the ONT sequencing through a number of attempts to discover the new PON link properties. In a first attempt, the ONT may enable first ones of a PON receive format and a PON content format 52 to be used in an attempt to match the corresponding formats of a new downstream signal 54. If no recognizable formats are found 56, such as if no synchronization or OAM cells are identified, for the first properties tried, a next content PON transmit format property and/or a PON content format property may be attempted to achieve a match with the downstream signal 58. This sequence may be repeated until a matching combination of transmit format and content format is found. After identifying the formats of the downstream signal, upstream signal formats may be determined 60. For example, an upstream transmission format, such as a bandwidth of the upstream signal may be determined by extracting the appropriate upstream signal format that has been previously encoded in the downstream signal. In another aspect, upstream/downstream format combinations may be provided, for example, in a look up table, so that the OLT can look up a specified upstream format associated with an identified downstream format. After the appropriate upstream formats are determined, the OLT may be configured to use these formats, such as a certain MAC code and a certain burst mode, to generate a properly formatted upstream signal. After configuring itself for receipt and transmission under a new PON scheme 62, the OLT may operate to receive and transmit information across the PON network.

Based on the foregoing specification, the methods described may be implemented using computer programming or engineering techniques including computer software, firmware, hardware or any combination or subset thereof, wherein the technical effect is to provide an adaptive ONT for automatically accommodating different types of PON networks. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware, such as a processors 14, 26, 32, to create a computer system or computer sub-system embodying the method of the invention. An apparatus for making, using or selling the invention may be one or more processing systems including, but not limited to, a central processing unit (CPU), memory, storage devices, communication links and devices, I/O devices, or any sub-components of one or more processing systems, including software, firmware, hardware or any combination or subset thereof, which embody the invention.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. A method for recognizing and adapting to a change in a passive optical network (PON) format by an optical network terminal (ONT) in communication with an optical line terminal (OLT) over the PON, comprising:
pre-loading a plurality of transmission formats and content formats into an individual ONT;
automatically identifying at the ONT a transmission format of a downstream signal transmitted over a PON from an OLT to the ONT corresponding to at least one of the preloaded transmission formats,
automatically identifying at the ONT a content format of the downstream signal corresponding to at least one of the preloaded content formats; and
automatically adapting the ONT to recover information from the downstream signal according to the identified transmission format and the identified content format.

2. The method of claim 1, further comprising automatically adapting the ONT to transmit an upstream signal to the OLT responsive to the identified transmission format and the identified content format.

3. The method of claim 2, wherein adapting the ONT to transmit an upstream signal according to the identified transmission format comprises configuring the ONT to transmit in a transmit burst mode encoded in the downstream signal.

4. The method of claim 2, wherein adapting the ONT to transmit an upstream signal according to the identified transmission format comprises configuring the ONT to transmit at a predetermined transmit burst mode corresponding to the identified transmission format.

5. The method of claim 4, wherein adapting the ONT to transmit an upstream signal responsive to the identified transmission format further comprises accessing a look-up table to retrieve the predetermined transmit burst mode corresponding to the identified transmission format.

6. The method of claim 1, wherein identifying the transmission format comprises recognizing at least one of a clock format or a data format of the downstream signal.

7. The method of claim 1, wherein identifying the content format comprises recognizing a media access control (MAC) code in the downstream signal.

8. The method of claim 7, wherein identifying a MAC code comprises recognizing an operation, administration, and management (OAM) code in the MAC code.

9. The method of claim 4, wherein identifying a MAC code comprises recognizing a synchronization code in the MAC code.

10. (canceled)

11. An optical network terminal (ONT) of a passive optical network (PON) for recognizing and adapting to a change in a PON format, comprising:
a receive adaptive unit for automatically identifying a transmission format of a downstream signal received at the ONT and for automatically adapting itself to recover data from the signal according to the identified transmission format; and
a content adaptive unit for automatically identifying a content format of the recovered data provided by the receive adaptive unit and for automatically adapting itself to interpret the recovered data according to the identified content format.

12. The ONT of claim 11, wherein the receive adaptive unit is configured for identifying at least one of a clock format and a data format of the downstream signal.

13. The ONT of claim 11, wherein the content adaptive unit is further configured for formatting a content of an upstream signal to be transmitted from the ONT responsive to the identified content format of the recovered data.

14. The ONT of claim 13, further comprising a transmit adaptive unit for configuring a transmission format of the content formatted upstream signal responsive the identified transmission format.

15. The ONT of claim 11, further comprising a data table accessible by the receive adaptive unit to store the identified transmission format and accessible by the transmit adaptive unit to retrieve a predetermined transmission format corresponding to the identified transmission format.

16. The ONT of claim 11, wherein the content format comprises a media access control (MAC) code.

17. The ONT of claim 16, wherein the MAC code comprises a signal synchronization code.

18. The ONT of claim 16, wherein the MAC code comprises an operations, administration, and management (OEM) code.

19. An optical network terminal (ONT) of a passive optical network (PON) for recognizing and adapting to a change in a PON format, comprising:
a content adaptive processor receiving data recovered from a downstream signal received at the ONT from an upstream optical line terminal (OLT);
a content format memory in communication with the content adaptive processor for storing different content formats;
logic executable by the content adaptive processor for sequentially comparing ones of the different content formats stored in the content format memory to a content format of the data recovered from the downstream signal, for identifying a content format match between one of the different content formats stored in content format memory and the content format of the data recovered from the downstream signal, and for providing content interpreted data to a downstream data user according to the content format match.

20. The ONT of claim 19, wherein the different content formats are preloaded into the content format memory.

21. The ONT of claim 19, further comprising a receive adaptive processor receiving the downstream signal from the OLT.

22. The ONT of claim 21, further comprising a receive format memory in communication with the receive adaptive processor for storing different receive formats.

23. The ONT of claim 22, further comprising logic executable by the receive adaptive processor for sequentially comparing ones of the different content receive formats stored in receive format memory to a receive format of the downstream signal; for identifying a receive format match between at least one of the different receive formats and the receive format of the downstream signal, and for providing recovered data to the content adaptive processor according to the receive format match.

24. The ONT of claim 22, wherein the different receive formats are preloaded into the receive format memory.

25. The ONT of claim 22, wherein the receive format memory further comprises a look up table storing a plurality of transmit formats corresponding to respective receive formats.

26. The ONT of claim 23, further comprising logic executable by the content adaptive processor for formatting a content of an upstream signal to be transmitted from the OLT according to the content format match;
a transmit format adaptive processor receiving a content formatted upstream signal from the content format adaptive processor; and
logic executable by the transmit format adaptive processor for configuring a transmission format of the content formatted upstream signal responsive to the receive format match,
wherein the transmit format adaptive processor is in communication with a look up table stored in the content format memory to retrieve a transmit format associated with the receive format of the downstream signal.

27. (canceled)

28. (canceled)
